(19) United States
(12) Patent Application Publication
(10) Pub. No.: US 2026/0291050 A1
(43) Pub. Date: Sep. 24, 2026

(54) ELECTRONIC DEVICE

(71) Applicant: COMPAL ELECTRONICS, INC., Taipei City (TW)

(72) Inventors: Dai-Yun Lin, Taipei City (TW); Shih-Chia Liu, Taipei City (TW); Jhih-Ciang Chen, Taipei City (TW); Li-Chun Lee, Taipei City (TW); Chih-Heng Lin, Taipei City (TW); Yu-Wei Chen, Taipei City (TW); Shih-Ping Liu, Taipei City (TW)

(73) Assignee: COMPAL ELECTRONICS, INC., Taipei City (TW)

(21) Appl. No.: 19/245,417

(22) Filed: Jun. 23, 2025

(30) Foreign Application Priority Data
Mar. 20, 2025 (TW) 114110596

(51) Int. Cl. H01Q 1/22; H01Q 1/38; H01Q 5/378

(52) U.S. Cl. CPC H01Q 1/2266; H01Q 1/38; H01Q 5/378

(57) ABSTRACT

An electronic device includes a first casing including a first closed slot, a second casing assembled with the first casing and including a second closed slot, and an antenna module including a substrate and an antenna structure. The substrate is disposed in the first casing and covers the first closed slot, and an orthographic projection of the first closed slot on the substrate at least partially overlaps an orthographic projection of the second closed slot on the substrate. The substrate has opposing first and second surfaces, with the first and second surfaces facing the first and second closed slots. The antenna structure is disposed on the second surface, and an orthographic projection of the antenna structure on the substrate at least partially overlaps the orthographic projection of the first closed slot on the substrate. The antenna structure is configured to be excited to generate a first high frequency resonance mode.

### CROSS-REFERENCE TO RELATED APPLICATION

This application claims the priority benefit of Taiwan application serial no. 114110596, filed on Mar. 20, 2025. The entirety of each of the above-mentioned patent application is hereby incorporated by reference herein and made a part of this specification.

### BACKGROUND

### Technical Field

The disclosure relates to an electronic device, and particularly relates to an electronic device including an antenna module.

### Description of Related Art

Existing portable electronic devices such as laptops, smartphones, etc., mostly have wireless communication functions. Generally, laptops are equipped with antennas to receive or transmit radio signals. Currently, with an emphasis on aesthetics, most laptop bodies are designed using all-metal. However, a metal body may pose more stringent challenges for the design of the antenna module.

Therefore, how to maintain the appearance design of the electronic device while also considering the radiation characteristics of the antenna module has become one of the problems to be solved in this field.

### SUMMARY

The disclosure provides an electronic device with good radiation characteristics of its antenna module.

An electronic device of the disclosure includes a first casing, a second casing, and an antenna module. The first casing includes a first closed slot. The second casing is assembled with the first casing and includes a second closed slot. The antenna module includes a substrate and an antenna structure. The substrate is disposed in the first casing and covers the first closed slot, and an orthographic projection of the first closed slot on the substrate at least partially overlaps an orthographic projection of the second closed slot on the substrate. The substrate has a first surface and a second surface opposite to each other. The first surface faces the first closed slot, and the second surface faces the second closed slot. The antenna structure is disposed on the second surface, and an orthographic projection of the antenna structure on the substrate at least partially overlaps the orthographic projection of the first closed slot on the substrate. The antenna structure is configured to be excited to generate a first high frequency resonance mode.

In an embodiment of the disclosure, the antenna module further includes a parasitic branch, located in the second closed slot, and the antenna structure and the parasitic branch are configured to resonate to generate a second high frequency resonance mode.

In an embodiment of the disclosure, the antenna structure includes a feeding portion, a radiating portion, a parasitic radiator, and a grounding portion, where an orthographic projection of the radiating portion on the first casing is located within the first closed slot.

In an embodiment of the disclosure, the first casing is a metal casing, and the grounding portion is disposed to connect the antenna structure with the metal casing.

In an embodiment of the disclosure, the radiating portion is L-shaped or T-shaped, and one end of the radiating portion is connected with the feeding portion.

In an embodiment of the disclosure, the parasitic radiator is L-shaped, and one end of the parasitic radiator is connected with the grounding portion.

In an embodiment of the disclosure, a length of the second closed slot is greater than or equal to a length of the first closed slot.

In an embodiment of the disclosure, a width of the second closed slot is greater than or equal to a width of the first closed slot.

In an embodiment of the disclosure, a length of the first closed slot is approximately half-wavelength of a resonant frequency.

In an embodiment of the disclosure, the first closed slot and the second closed slot are covered or filled with non-conductive materials.

In an embodiment of the disclosure, the second casing further includes a third closed slot, and the second closed slot and the third closed slot extend in a same direction.

In an embodiment of the disclosure, there is a distance between the second closed slot and the third closed slot in the direction.

In an embodiment of the disclosure, the distance is less than or equal to 3 millimeters.

In an embodiment of the disclosure, a length of the first closed slot is greater than a combined length of the second closed slot and the third closed slot arranged in parallel.

In an embodiment of the disclosure, the first closed slot is configured to be excited to generate a first low frequency resonance mode.

In an embodiment of the disclosure, the second closed slot is configured to be excited to generate a first low frequency resonance mode.

Based on the above, in the electronic device of the disclosure, the first casing includes the first closed slot, and the second casing includes the second closed slot. The first closed slot and the second closed slot are opposite to each other. The substrate of the antenna module is disposed in the first casing and covers the first closed slot. The antenna structure is disposed on the substrate and faces the second closed slot. The orthographic projection of the antenna structure on the substrate at least partially overlaps the orthographic projection of the first closed slot on the substrate. The antenna structure is configured to be excited to generate a first high frequency resonance mode.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic three-dimensional view of an electronic device according to an embodiment of the disclosure.

FIG. 2 is a schematic cross-sectional view of the electronic device of FIG. 1 along section line A-A′.

FIG. 3 is a partially enlarged cross-sectional view of the electronic device of FIG. 1 from another viewing angle.

FIG. 4 is a schematic front view of the first body of FIG. 1 with partial components omitted.

FIG. 5A is a schematic three-dimensional view of an electronic device according to an embodiment of the disclosure.

FIG. 5B is a schematic cross-sectional view of the electronic device of FIG. 5A along section line B-B′.

FIG. 5C is a schematic front view of the electronic device of FIG. 5A with partial components omitted.

FIG. 5D is a frequency-S parameter relationship diagram of the antenna module of FIG. 5C.

FIG. 6A is a schematic three-dimensional cross-sectional view of an electronic device according to an embodiment of the disclosure.

FIG. 6B is a schematic three-dimensional view of the electronic device of FIG. 6A from another viewing angle.

FIG. 6C is a schematic front view of the electronic device of FIG. 6B.

FIG. 6D is a frequency-S parameter relationship diagram of the antenna module of FIG. 6C.

FIG. 7A is a schematic three-dimensional view of an electronic device according to an embodiment of the disclosure.

FIG. 7B is a schematic three-dimensional view of the electronic device of FIG. 7A from another viewing angle.

FIG. 8A is a schematic three-dimensional view of the electronic device of FIG. 7A from another viewing angle.

FIG. 8B is a schematic three-dimensional view of the electronic device of FIG. 8A with partial components omitted.

FIG. 8C is a schematic perspective view of the electronic device of FIG. 8A.

FIG. 8D is a schematic front view of the electronic device of FIG. 8A.

FIG. 8E is a frequency-S parameter relationship diagram of the antenna module of FIG. 8C.

### DESCRIPTION OF THE EMBODIMENTS

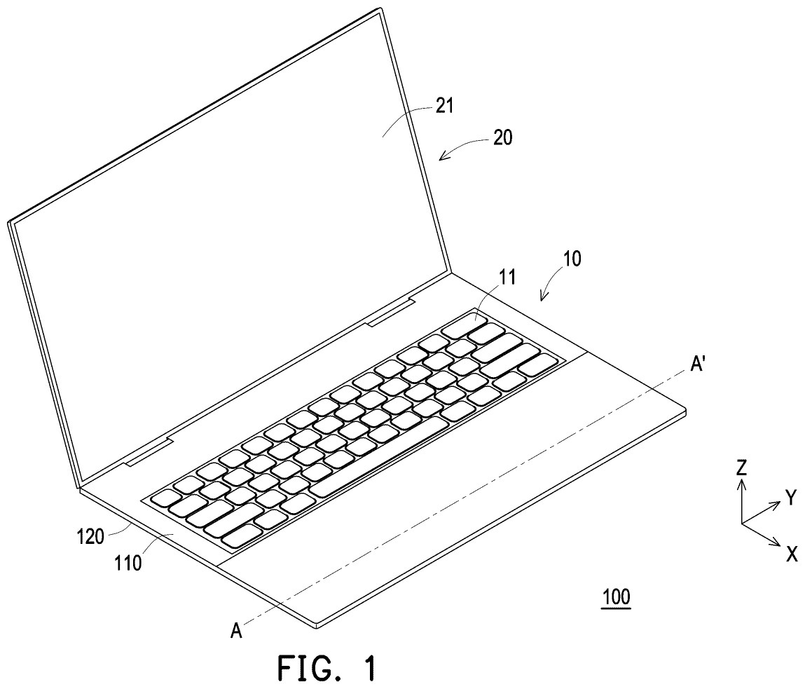

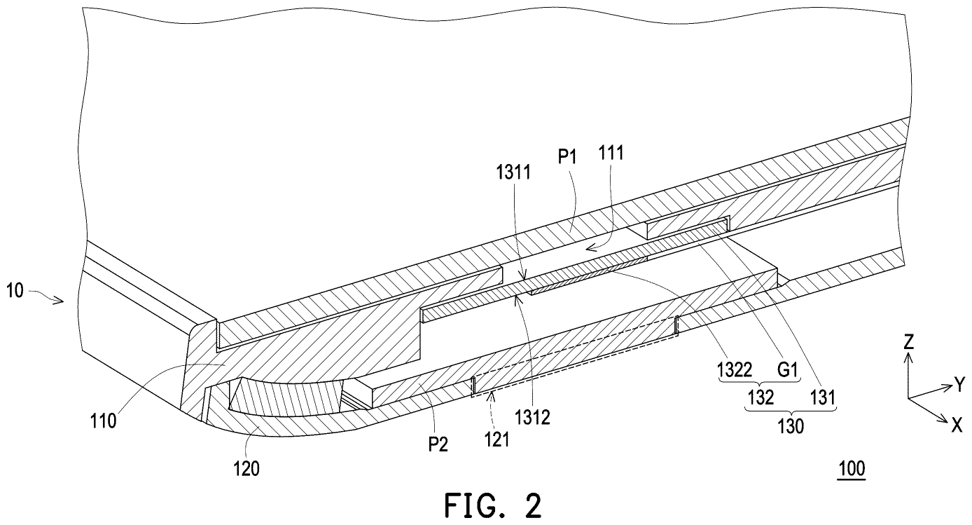

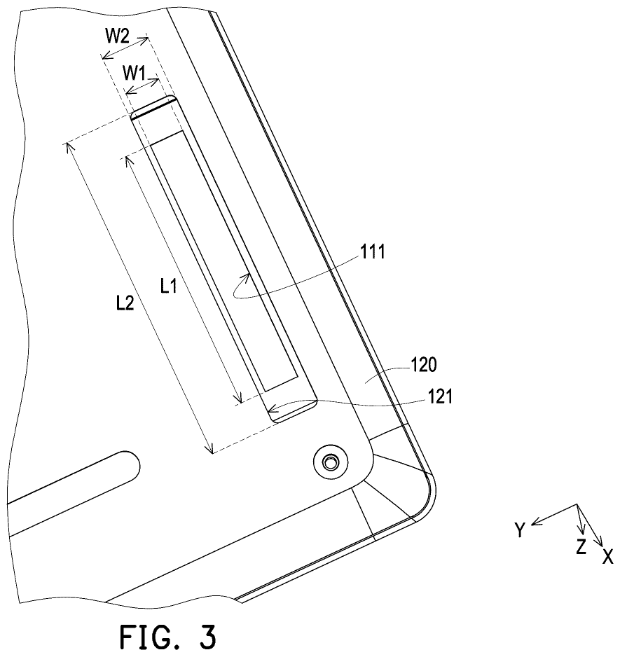

FIG. 1 is a schematic three-dimensional view of an electronic device according to an embodiment of the disclosure. FIG. 2 is a schematic cross-sectional view of the electronic device of FIG. 1 along section line A-A′. FIG. 3 is a partially enlarged cross-sectional view of the electronic device of FIG. 1 from another viewing angle. It should be noted that FIG. 3 is a back view of the electronic device 100 of FIG. 1 turned to the back side. In order to clearly show the relative position of the first closed slot 111 and the second closed slot 121 in the embodiment, FIG. 3 omits the drawing of non-conductive materials P1, P2 and the antenna module 130. The embodiment also provides a rectangular coordinate system X-Y-Z to facilitate component identification.

Referring to FIG. 1 first, an electronic device 100 of the embodiment is, for example, a laptop computer, including a first body 10 and a second body 20. The first body 10 is pivotally connected to the second body 20. In the embodiment, the first body 10 is a logic body, having a keyboard 11, and the second body 20 is a display body, having a display screen 21, but the type of the electronic device 100 is not limited thereto. In other embodiments, the electronic device 100 may also be a tablet computer, and the type of the electronic device 100 is not limited thereto.

Referring to FIG. 2 and FIG. 3, the electronic device 100 of the embodiment includes a first casing 110, a second casing 120, and an antenna module 130. Specifically, the first casing 110 is a keyboard frame (also known as C component), and the second casing 120 is a bottom case (also known as D component). The first body 10 is assembled from the first casing 110 and the second casing 120. The antenna module 130 is disposed in the first body 10, but the disclosure is not limited thereto. In other embodiments, the antenna module 130 may also be disposed in the second body 20, and the configuration of the antenna module 130 is not limited thereto.

In the embodiment, the first casing 110 includes a first closed slot 111. The second casing 120 includes a second closed slot 121. The first closed slot 111 and the second closed slot 121 are disposed in a vertically aligned and stacked arrangement. Both the first closed slot 111 and the second closed slot 121 contain two closed ends.

In the embodiment, the first casing 110 and the second casing 120 are metal casings, which may be composed of one or more metal components respectively, but are not limited thereto. In the embodiment, the first closed slot 111 is covered by a non-conductive material P1, and the second closed slot 121 is filled with a non-conductive material P2, but the disclosure is not limited thereto. In other embodiments, the first closed slot may also be filled with a non-conductive material, and the second closed slot may also be covered by a non-conductive material, but the disclosure is not limited thereto. The non-conductive materials P1, P2 are, for example, plastic structures, but the disclosure is not limited thereto.

In the embodiment, the antenna module 130 includes a substrate 131 and an antenna structure 132. The substrate 131 is disposed in the first casing 110 and covers the first closed slot 111, and an orthographic projection of the first closed slot 111 on the substrate 131 at least partially overlaps an orthographic projection of the second closed slot 121 on the substrate 131.

Under the above configuration, the design of mutually aligned (stacked) slots on the casing used as part of the antenna may be applied to metal case designs, which also provides feasibility for integrating the antenna with other non-metal components, such as a speaker, but the disclosure is not limited thereto.

In the embodiment, the substrate 131, is, for example, a circuit board, but is not limited thereto. The substrate 131 has a first surface 1311 and a second surface 1312 opposite to each other. The first surface 1311 faces the first closed slot 111, and the second surface 1312 faces the second closed slot 121. The antenna structure 132 is disposed on the second surface 1312, and an orthographic projection of the antenna structure 132 on the substrate 131 at least partially overlaps the orthographic projection of the first closed slot 111 on the substrate 131.

In the embodiment, the antenna structure 132 is configured to be excited to generate a first high frequency resonance mode. The first closed slot 111 is configured to be excited to generate a first low frequency resonance mode. Specifically, in an embodiment, a length L1 of the first closed slot 111 is approximately half-wavelength of a resonant frequency (2.4 GHz), but the disclosure is not limited thereto. In an embodiment, in an X direction, a length L2 of the second closed slot 121 is slightly larger than the length L1 of the first closed slot 111. In a Y direction, a width W2 of the second closed slot 121 is slightly larger than a width W1 of the first closed slot 111. In other embodiments, the length L2 of the second closed slot 121 may also be equal to the length L1 of the first closed slot 111, and the width W2 of the second closed slot 121 may also be equal to the width W1 of the first closed slot 111, but the disclosure is not limited thereto.

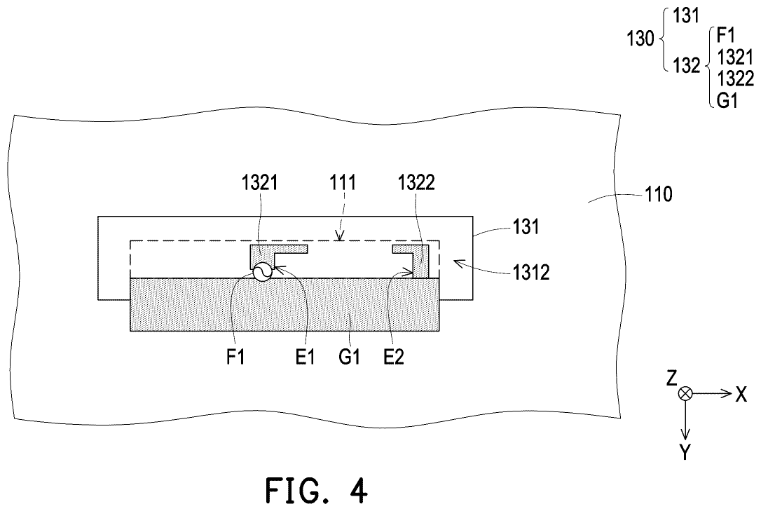

FIG. 4 is a schematic front view of the first body of FIG. 1 with partial components omitted. It should be noted that the drawing of the second casing 120 is omitted in FIG. 4. Referring to FIG. 4, in the embodiment, the antenna structure 132 includes a feeding portion F1, a radiating portion 1321, a parasitic radiator 1322, and a grounding portion G1, where an orthographic projection of the radiating portion 1321 on the first casing 110 is located within the first closed slot 111.

In the embodiment, the radiating portion 1321 is L-shaped and one end E1 of the radiating portion 1321 is connected with the feeding portion F1. In other embodiments, the radiating portion 1321 may be T-shaped, but the disclosure is not limited thereto.

In the embodiment, the parasitic radiator 1322 is L-shaped and one end E2 of the parasitic radiator 1322 is connected with the grounding portion G1.

In the embodiment, the grounding portion G1 is disposed to connect the antenna structure 132 with the first casing 110 made of metal material.

In an embodiment, the first closed slot 111 resonates with the radiating portion 1321 and the parasitic radiator 1322 to generate 5 GHz and 6 GHz frequencies, but the disclosure is not limited thereto. As a result, the antenna module 130 may form a multi-mode design, allowing the electronic device 100 to maintain the appearance design of the metal casing while preserving good radiation characteristics of the antenna module 130.

The following will list other embodiments for illustration. Note that the reference numerals and a part of the contents in the previous embodiment are applicable to the following embodiments, in which identical reference numerals indicate identical or similar components, and repeated descriptions of the same technical contents are omitted. For the detailed descriptions of the omitted parts, reference can be found in the previous embodiment, and no repeated description is contained in the following embodiments.

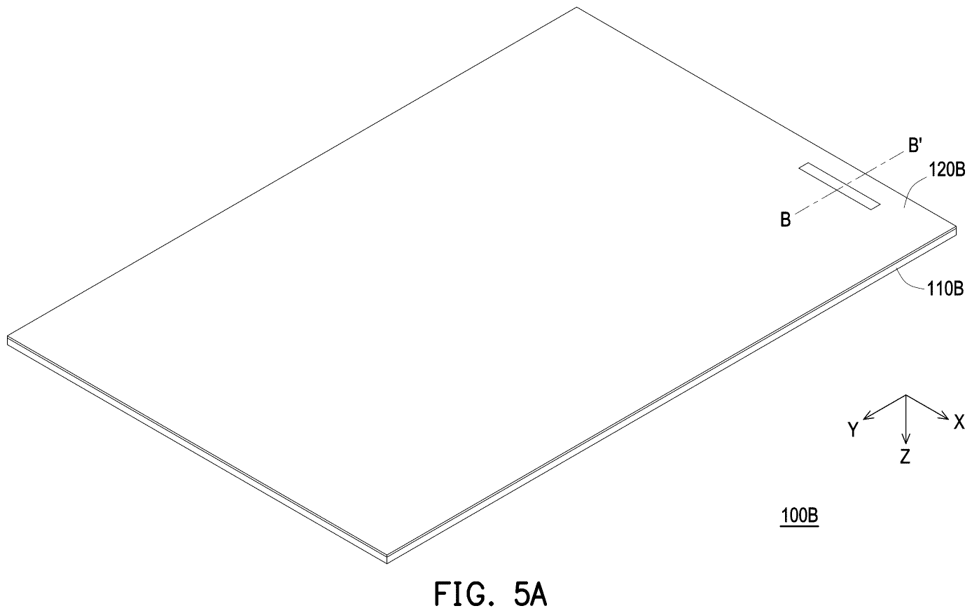

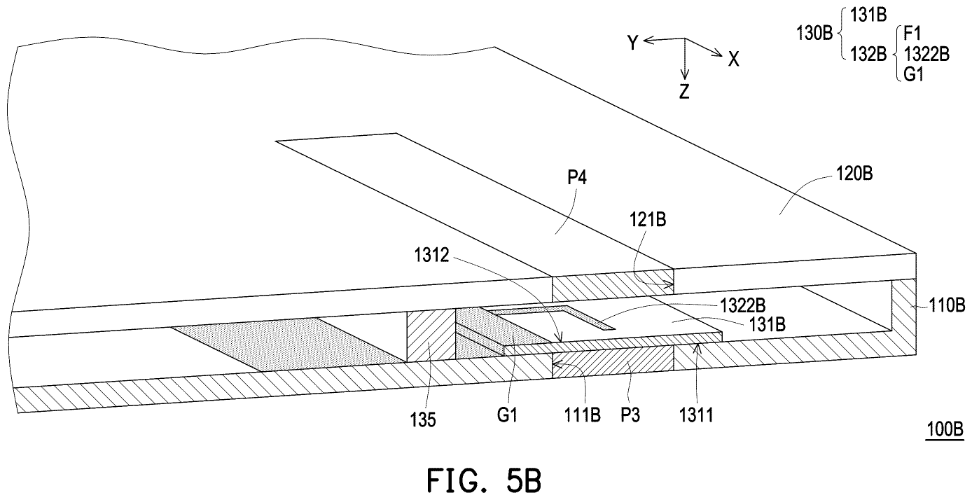

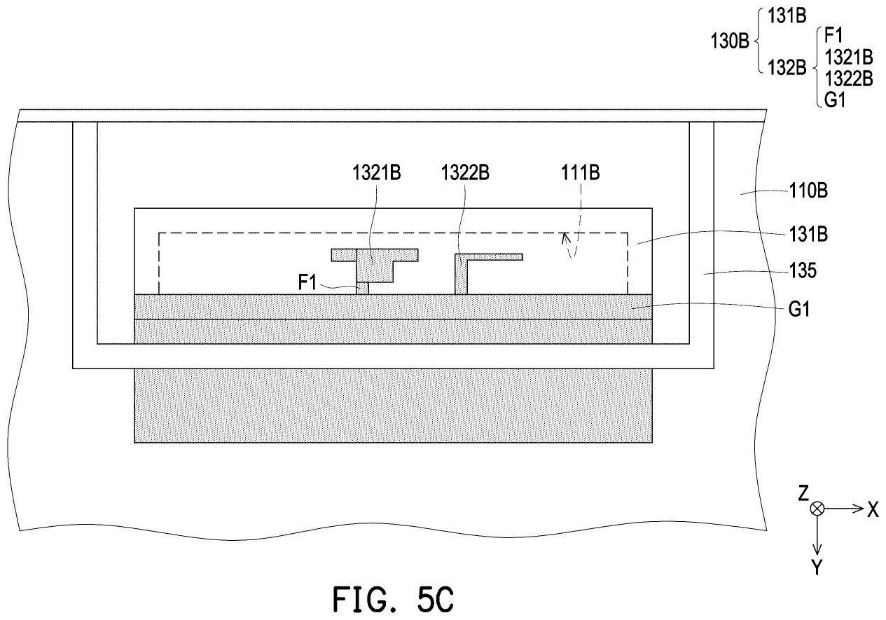

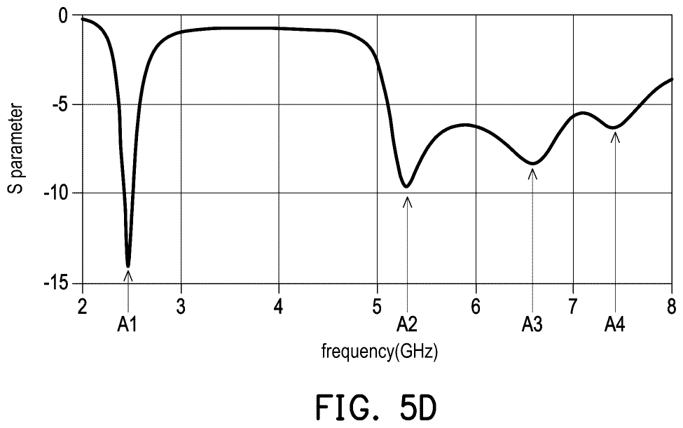

FIG. 5A is a schematic three-dimensional view of an electronic device according to an embodiment of the disclosure. FIG. 5B is a schematic cross-sectional view of the electronic device of FIG. 5A along section line B-B′. FIG. 5C is a schematic front view of the electronic device of FIG. 5A with partial components omitted. FIG. 5D is a frequency-S parameter relationship diagram of the antenna module of FIG. 5C. It should be noted that some non-relevant structures in FIG. 5A and FIG. 5B will be omitted to facilitate the display and identification of the required component parts.

Referring first to FIG. 5A and FIG. 5B, an electronic device 100B of the embodiment includes a first casing 110B, a second casing 120B, and an antenna module 130B. Specifically, the first casing 110B is a keyboard frame (also known as C component), and the second casing 120B is a bottom case (also known as D component), but the disclosure is not limited thereto.

In the embodiment, an orthographic projection of a first closed slot 111B on a substrate 131B at least partially overlaps an orthographic projection of a second closed slot 121B on the substrate 131B. An orthographic projection of an antenna structure 132B on the substrate 131B at least partially overlaps the orthographic projection of the first closed slot 111B on the substrate 131B.

In the embodiment, the first casing 110B and the second casing 120B are metal casings, which may be composed of one or more metal components respectively, but are not limited thereto. In the embodiment, the first closed slot 111B is filled with a non-conductive material P3, and the second closed slot 121B is filled with a non-conductive material P4, but the disclosure is not limited thereto. The non-conductive materials P3, P4 are, for example, plastic structures, but the disclosure is not limited thereto.

Referring to FIG. 5C, in the embodiment, a radiating portion 1321B is T-shaped, and a parasitic radiator 1322B is L-shaped, but the disclosure is not limited thereto. In an embodiment, the antenna module 130B further includes a conductive wall structure 135, but the disclosure is not limited thereto.

In the embodiment, the antenna structure 132B is configured to be excited to generate a first high frequency resonance mode. The first closed slot 111B is configured to be excited to generate a first low frequency resonance mode. In an embodiment, a length of the first closed slot 111B is approximately half-wavelength of a resonant frequency (2.4 GHz), but the disclosure is not limited thereto. In an embodiment, the first closed slot 111B resonates with the radiating portion 1321B and the parasitic radiator 1322B to generate 5 GHz and 6 GHz frequencies, but the disclosure is not limited thereto.

Furthermore, a position A1 referred to in FIG. 5D indicates the frequency generated by the resonance of the first closed slot 111B, a position A2 referred to in FIG. 5D indicates the frequency generated by the resonance (second harmonic) of the first closed slot 111B, a position A3 referred to in FIG. 5D indicates the frequency generated by the resonance of the radiating portion 1321B, and a position A4 referred to in FIG. 5D indicates the frequency generated by the resonance of the parasitic radiator 1322B. As a result, the antenna module 130B may form a multi-mode design, allowing the electronic device 100B to maintain the appearance design of the metal casing while preserving good radiation characteristics of the antenna module 130B.

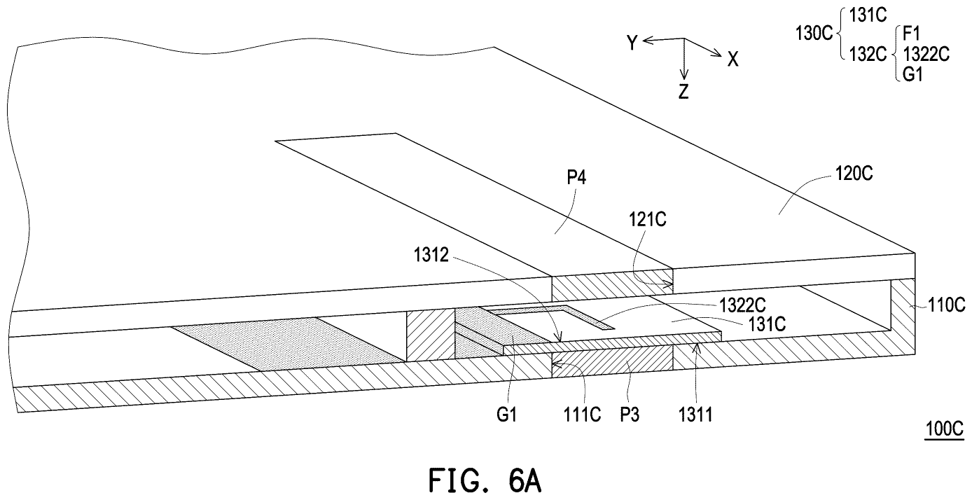

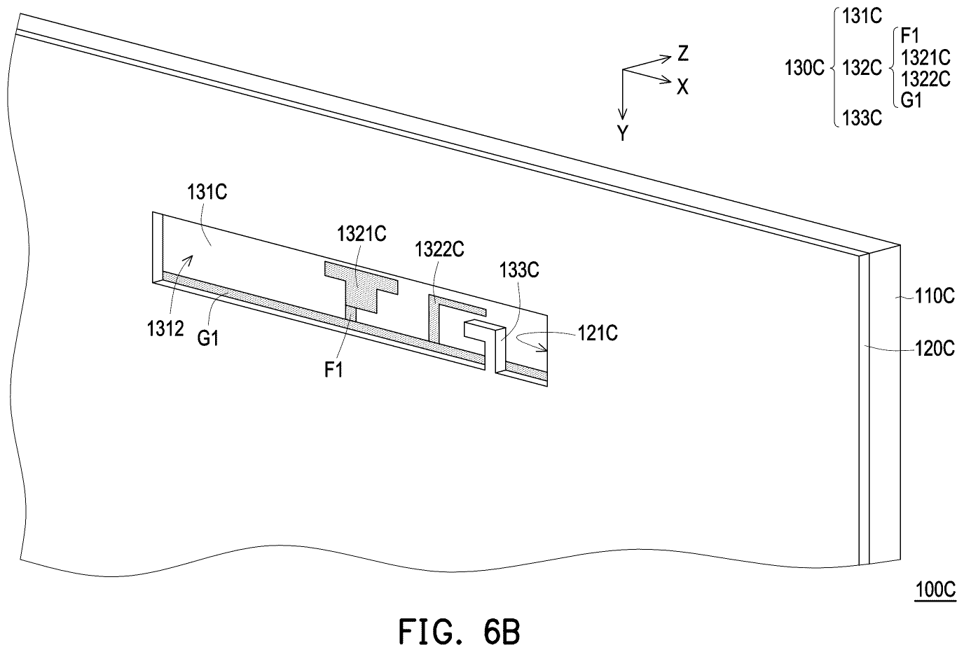

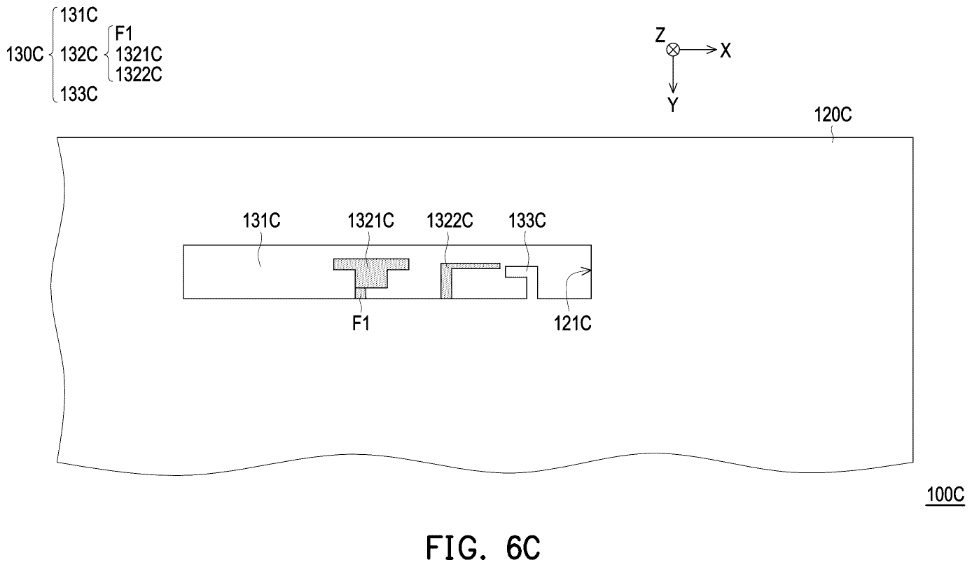

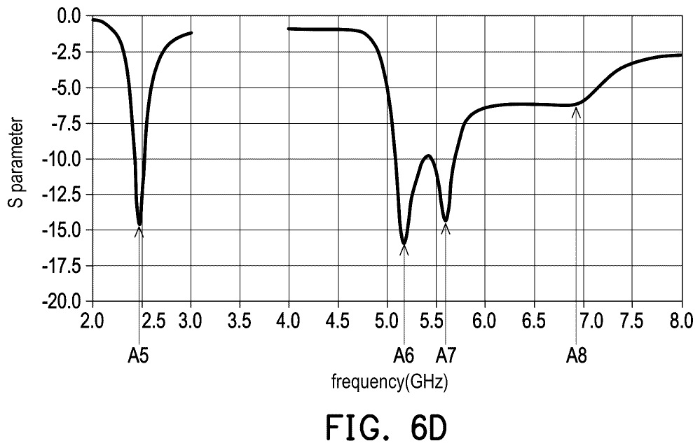

FIG. 6A is a schematic three-dimensional cross-sectional view of an electronic device according to an embodiment of the disclosure. FIG. 6B is a schematic three-dimensional view of the electronic device of FIG. 6A from another viewing angle. FIG. 6C is a schematic front view of the electronic device of FIG. 6B. FIG. 6D is a frequency-S parameter relationship diagram of the antenna module of FIG. 6C. It should be noted that FIG. 6B and FIG. 6C have omitted the drawing of the non-conductive material P4 to facilitate the display of the components behind it.

Referring to FIG. 6A to FIG. 6C, an electronic device 100C of the embodiment includes a first casing 110C, a second casing 120C, and an antenna module 130C. Specifically, the first casing 110C is a keyboard frame (also called C component), and the second casing 120C is a bottom case (also called D component), but the disclosure is not limited thereto.

In the embodiment, an orthographic projection of a first closed slot 111C on a substrate 131C at least partially overlaps an orthographic projection of a second closed slot 121C on the substrate 131C. An orthographic projection of an antenna structure 132C on the substrate 131C at least partially overlaps the orthographic projection of the first closed slot 111C on the substrate 131C.

In the embodiment, the antenna structure 132C is configured to be excited to generate a first high frequency resonance mode. The first closed slot 111C is configured to be excited to generate a first low frequency resonance mode. In an embodiment, a length of the first closed slot 111C is approximately half-wavelength of a resonant frequency (2.4 GHz), but the disclosure is not limited thereto. In an embodiment, the first closed slot 111C resonates with a radiating portion 1321C and a parasitic radiator 1322C to generate 5 GHz and 6 GHz frequencies, but the disclosure is not limited thereto.

In the embodiment, the electronic device 100C in FIG. 6B is slightly different from the electronic device 100B in FIG. 5C, with the main difference being: the antenna module 130C further includes a parasitic branch 133C. The parasitic branch 133C is located in the second closed slot 121C. The antenna structure 132C and the parasitic branch 133C are configured to resonate to generate a second high frequency resonance mode.

In the embodiment, the parasitic branch 133C is L-shaped, but the disclosure is not limited thereto. The parasitic branch 133C is a metal structure extending from the metal second casing 120C, extending inward from the edge of the second closed slot 121C, but the disclosure is not limited thereto.

Referring to FIG. 6D, a position A5 referred to in FIG. 6D indicates the frequency generated by the resonance of the first closed slot 111C, a position A6 referred to in FIG. 6D indicates the frequency generated by the resonance (second harmonic) of the first closed slot 111C, a position A7 referred to in FIG. 6D indicates the frequency generated by the resonance of the parasitic branch 133C with the parasitic radiator 1322C, and a position A8 referred to in FIG. 6D indicates the frequency generated by the resonance of the radiating portion 1321C. As a result, the antenna module 130C may form a multi-mode design, allowing the electronic device 100C to maintain the appearance design of the metal casing while preserving good radiation characteristics of the antenna module 130C.

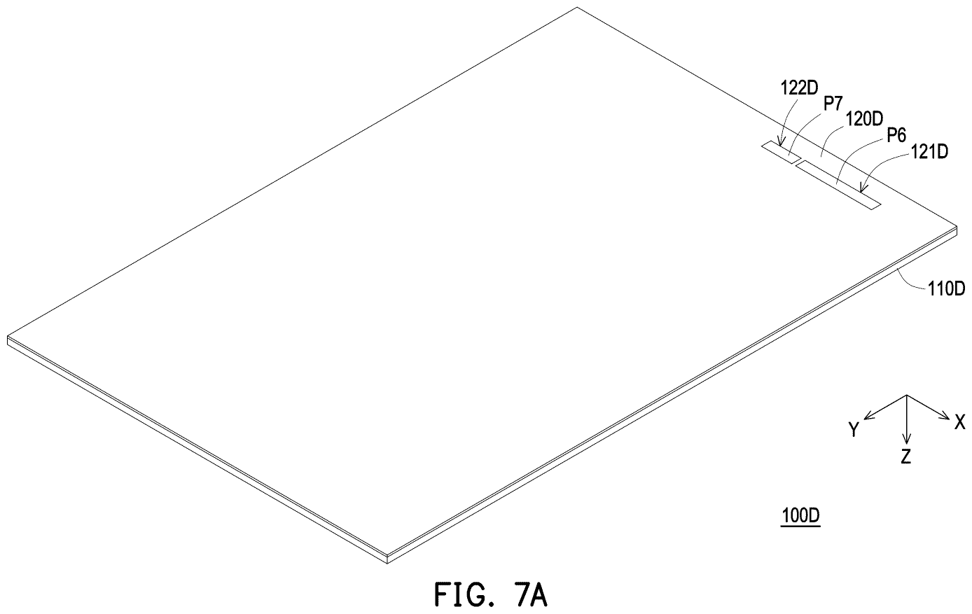

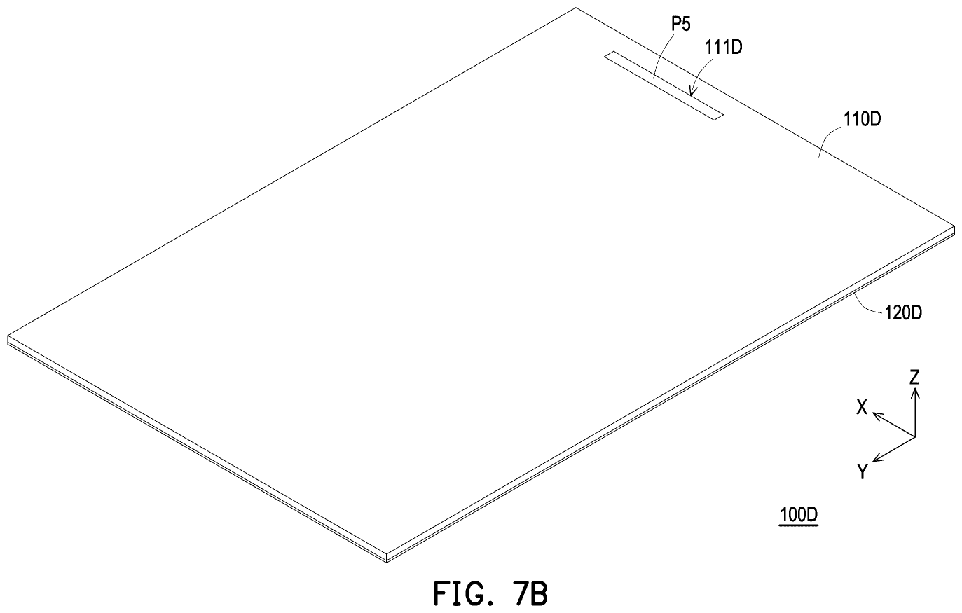

FIG. 7A is a schematic three-dimensional view of an electronic device according to an embodiment of the disclosure. FIG. 7B is a schematic three-dimensional view of the electronic device of FIG. 7A from another viewing angle. It should be noted that FIG. 7B is a back view of the electronic device 100D of FIG. 7A turned to the back side.

Referring first to FIG. 7A and FIG. 7B, an electronic device 100D of the embodiment includes a first casing 110D and a second casing 120D. Specifically, the first casing 110D is a keyboard frame (also known as C component), and the second casing 120D is a bottom case (also known as D component), but the disclosure is not limited thereto.

In the embodiment, the electronic device 100D in FIG. 7A is slightly different from the electronic device 100B in FIG. 5A, with the main difference being: the second casing 120D further includes a third closed slot 122D, and a second closed slot 121D and the third closed slot 122D extend in a same direction, such as the X direction, but not limited thereto. A first closed slot 111D and the second closed slot 121D and the third closed slot 122D are disposed in a vertically aligned and stacked arrangement. The first closed slot 111D, the second closed slot 121D, and the third closed slot 122D all contain two closed ends.

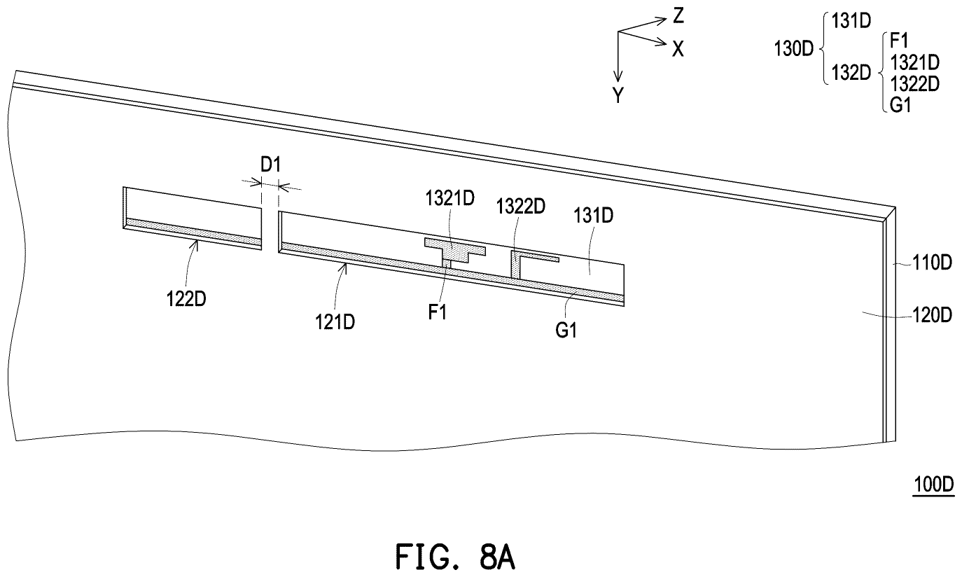

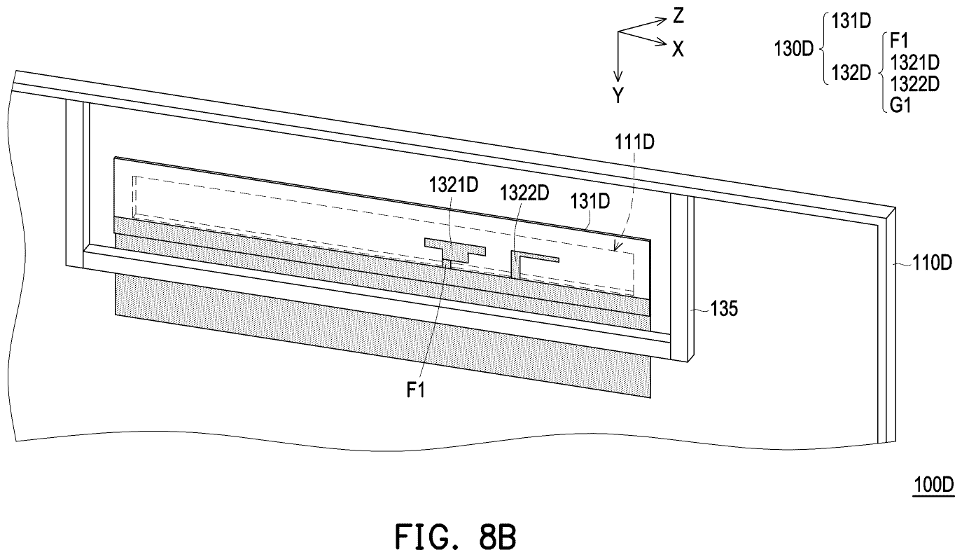

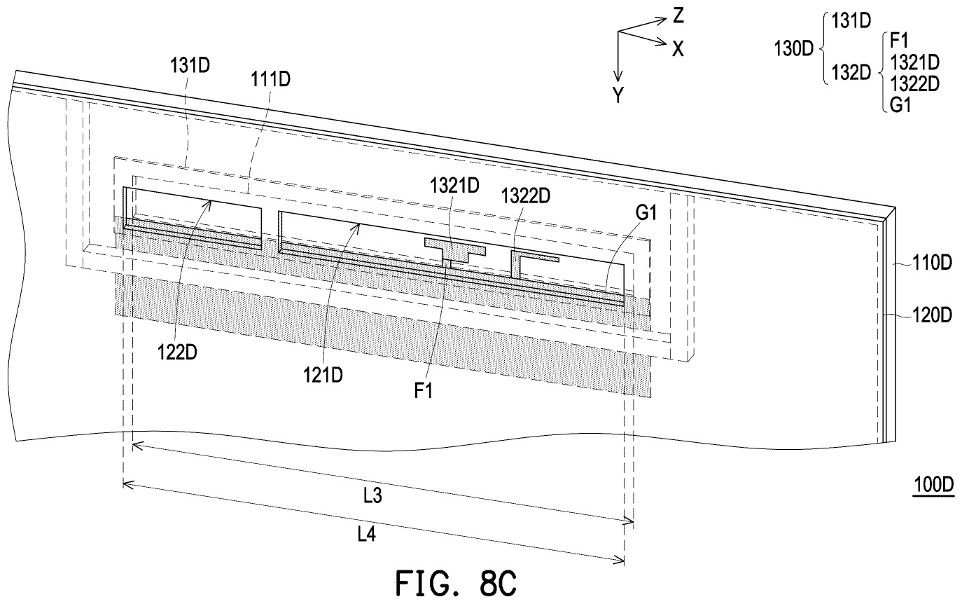

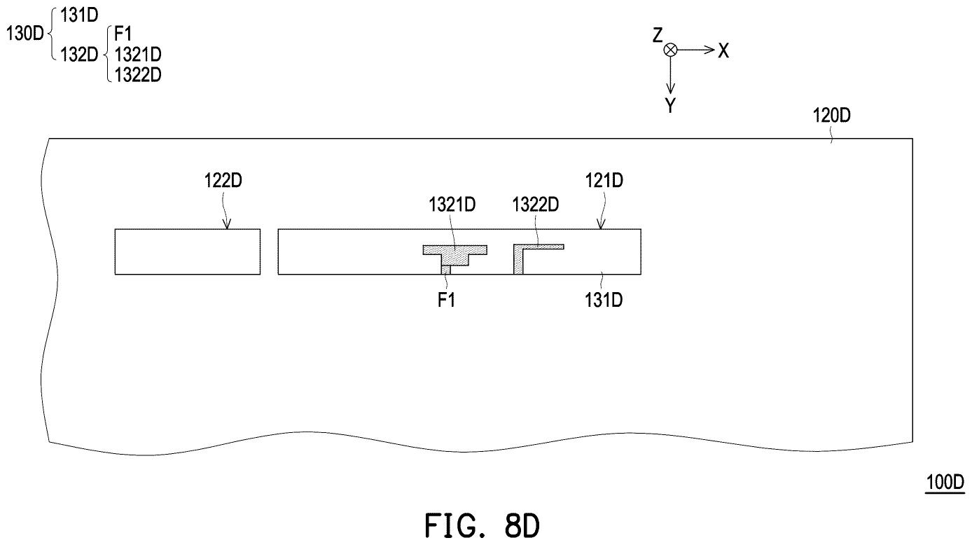

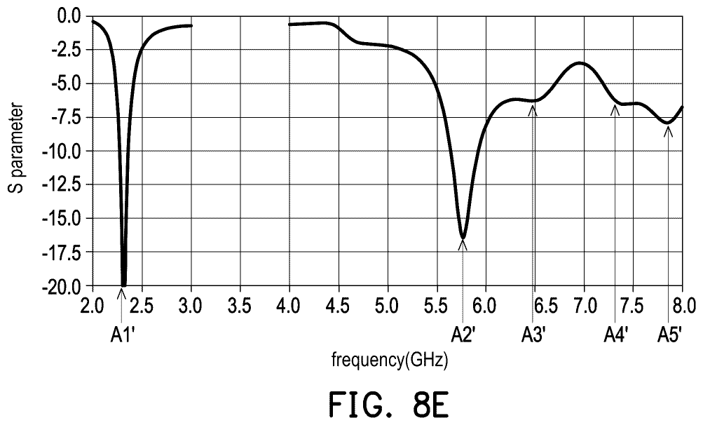

FIG. 8A is a schematic three-dimensional view of the electronic device of FIG. 7A from another viewing angle. FIG. 8B is a schematic three-dimensional view of the electronic device of FIG. 8A with partial components omitted. FIG. 8C is a schematic perspective view of the electronic device of FIG. 8A. FIG. 8D is a schematic front view of the electronic device of FIG. 8A. FIG. 8E is a frequency-S parameter relationship diagram of the antenna module of FIG. 8C. It should be noted that FIG. 8B omits the drawing of the second casing 120D. In FIG. 8C, the second casing 120D is transparent to facilitate the display of components behind it. In order to clearly see an antenna structure 132D of the embodiment, FIG. 8A to FIG. 8D omit the drawing of non-conductive materials P6, P7 to facilitate the display of components behind them.

Referring to FIG. 8A, there is a distance D1 between the second closed slot 121D and the third closed slot 122D in the X direction. The distance D1 is less than or equal to 3 millimeters or less than or equal to one-tenth of a wavelength of high frequency (high frequency: ranges above 5 GHz are considered high frequency), but the disclosure is not limited thereto.

Referring to FIG. 8B and FIG. 8C, in the embodiment, an orthographic projection of the first closed slot 111D on a substrate 131D at least partially overlaps an orthographic projection of the second closed slot 121D and the third closed slot 122D on the substrate 131D. An orthographic projection of an antenna structure 132D on the substrate 131D at least partially overlaps the orthographic projection of the first closed slot 111D on the substrate 131D.

Referring to FIG. 8B, in an embodiment, an antenna module 130D further includes a conductive wall structure 135, but the disclosure is not limited thereto.

Referring to FIG. 8C, in an embodiment, in the X direction, a length L3 of the first closed slot 111D is slightly greater than a length L4 of the second closed slot 121D and the third closed slot 122D in parallel, but the disclosure is not limited thereto.

In the embodiment, the first casing 110D and the second casing 120D are metal casings, which may be composed of one or more metal components respectively, but are not limited thereto. In the embodiment, the first closed slot 111D is filled with a non-conductive material P5, the second closed slot 121D is filled with a non-conductive material P6, and the third closed slot 122D is filled with a non-conductive material P7, but the disclosure is not limited thereto. The non-conductive materials P5, P6, P7 are, for example, plastic structures, but the disclosure is not limited thereto.

Referring to FIG. 8D, in the embodiment, a radiating portion 1321D is T-shaped, and a parasitic radiator 1322D is L-shaped, but the disclosure is not limited thereto.

In the embodiment, the antenna structure 132D is configured to be excited to generate a first high frequency resonance mode. The second closed slot 121D is configured to be excited to generate a first low frequency resonance mode. In an embodiment, the length of the first closed slot 111D is approximately half-wavelength of a resonant frequency (2.4 GHz), but the disclosure is not limited thereto. In an embodiment, the first closed slot 111D resonates with the radiating portion 1321D and the parasitic radiator 1322D to generate 5 GHz and 6 GHz frequencies, but the disclosure is not limited thereto.

Furthermore, a position A1′ referred to in FIG. 8E indicates the frequency generated by the resonance of the second closed slot 121D, the position A2′ referred to in FIG. 8E indicates the frequency generated by the resonance (second harmonic) of the second closed slot 121D, the position A3′ referred to in FIG. 8E indicates the frequency generated by the resonance of the radiating portion 1321D, the position A4′ referred to in FIG. 8E indicates the frequency generated by the resonance of the parasitic radiator 1322D, the position A5′ referred to in FIG. 8E indicates the frequency generated by the resonance of the first closed slot 111D plus the third closed slot 122D. As a result, the antenna module 130D may form a multi-mode design, allowing the electronic device 100D to maintain the appearance design of the metal casing while preserving good radiation characteristics of the antenna module 130D.

In summary, in the electronic device of the disclosure, the first casing includes the first closed slot, and the second casing includes the second closed slot. The first closed slot and the second closed slot are opposite to each other. The substrate of the antenna module is disposed in the first casing and covers the first closed slot. The antenna structure is disposed on the substrate and faces the second closed slot. The orthographic projection of the antenna structure on the substrate at least partially overlaps the orthographic projection of the first closed slot on the substrate. As a result, the antenna module may form a multi-mode design, allowing the electronic device to maintain the appearance design of the metal casing while preserving good radiation characteristics of the antenna module.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An electronic device, comprising:
a first casing, comprising a first closed slot;
a second casing, assembled with the first casing, and comprising a second closed slot; and
an antenna module, comprising:
a substrate, disposed in the first casing, and covering the first closed slot, wherein an orthographic projection of the first closed slot on the substrate at least partially overlaps an orthographic projection of the second closed slot on the substrate, the substrate has opposite first and second surfaces, the first surface faces the first closed slot, and the second surface faces the second closed slot; and
an antenna structure, disposed on the second surface, wherein an orthographic projection of the antenna structure on the substrate at least partially overlaps an orthographic projection of the first closed slot on the substrate, wherein
the antenna structure is configured to be excited to generate a first high frequency resonance mode.

2. The electronic device according to claim 1, wherein the antenna module further comprises a parasitic branch, located in the second closed slot, the antenna structure and the parasitic branch are configured to resonate to generate a second high frequency resonance mode.

3. The electronic device according to claim 1, wherein the antenna structure comprises a feeding portion, a radiating portion, a parasitic radiator, and a grounding portion, wherein an orthographic projection of the radiating portion on the first casing is located within the first closed slot.

4. The electronic device according to claim 3, wherein the first casing is a metal casing, and the grounding portion is disposed to connect the antenna structure with the metal casing.

5. The electronic device according to claim 3, wherein the radiating portion is L-shaped or T-shaped, and one end of the radiating portion is connected with the feeding portion.

6. The electronic device according to claim 3, wherein the parasitic radiator is L-shaped, and one end of the parasitic radiator is connected with the grounding portion.

7. The electronic device according to claim 1, wherein a length of the second closed slot is greater than or equal to a length of the first closed slot.

8. The electronic device according to claim 1, wherein a width of the second closed slot is greater than or equal to a width of the first closed slot.

9. The electronic device according to claim 1, wherein a length of the first closed slot is approximately half-wavelength of a resonant frequency.

10. The electronic device according to claim 1, wherein the first closed slot and the second closed slot are covered or filled with non-conductive materials.

11. The electronic device according to claim 1, wherein the second casing further comprises a third closed slot, and the second closed slot and the third closed slot extend in a same direction.

12. The electronic device according to claim 11, wherein there is a distance between the second closed slot and the third closed slot in the direction.

13. The electronic device according to claim 12, wherein the distance is less than or equal to 3 millimeters.

14. The electronic device according to claim 11, wherein a length of the first closed slot is greater than a combined length of the second closed slot and the third closed slot arranged in parallel.

15. The electronic device according to claim 1, wherein the first closed slot is configured to be excited to generate a first low frequency resonance mode.

16. The electronic device according to claim 1, wherein the second closed slot is configured to be excited to generate a first low frequency resonance mode.
